(19) United States
(12) Patent Application Publication
(10) Pub. No.: US 2026/0154839 A1
(43) Pub. Date: Jun. 4, 2026

(54) METHOD AND APPARATUS FOR DETECTING REFLECTION SYMMETRY AXIS

(71) Applicant: POSTECH RESEARCH AND BUSINESS DEVELOPMENT FOUNDATION, Pohang-si (KR)

(72) Inventors: Minsu CHO, Pohang-si (KR); Won-gyun YU, Pohang-si (KR); AHYUN SEO, Pohang-si (KR)

(73) Assignee: POSTECH RESEARCH AND BUSINESS DEVELOPMENT FOUNDATION, Pohang-si (KR)

(21) Appl. No.: 19/404,717

(22) Filed: Dec. 1, 2025

(30) Foreign Application Priority Data
Dec. 2, 2024 (KR) 10-2024-0176575
Nov. 4, 2025 (KR) 10-2025-0164455

(51) Int. Cl. G06T 7/68; G06V 10/74; G06V 10/75; G06V 10/77

(52) U.S. Cl. CPC G06T 7/68; G06V 10/753; G06V 10/761; G06V 10/7715

(57) ABSTRACT

An electronic device includes at least one processor including processing circuitry, and memory storing instructions that, when executed by the at least one processor individually or collectively, cause the electronic device to extract an equivariant feature map by applying an equivariant backbone to an input image, generate a reflection similarity map by performing reflectional matching based on the equivariant feature map, predict initial parameters of a reflection axis based on the equivariant feature map and the reflection similarity map, and determine parameters of a reflection symmetry axis by performing orientational anchor expansion on the initial parameters.

### CROSS-REFERENCE TO RELATED APPLICATIONS

This application claims the benefit of Korean Patent Application No. 10-2024-0176575, filed on Dec. 2, 2024, and Korean Patent Application No. 10-2025-0164455, filed on Nov. 4, 2025, in the Korean Intellectual Property Office, the entire disclosures of which are incorporated herein by reference for all purposes.

### ACKNOWLEDGEMENT

This work was supported by IITP grants (RS-2022-II220290: Visual Intelligence for Space-Time Understanding & Generation (60%), RS-2024-00457882: National AI Research Lab Project (35%), RS-2019-II191906: AI Graduate School Program at POSTECH (5%)) funded by Ministry of Science and ICT, Korea.

### BACKGROUND

### 1. Field of the Invention

The disclosure relates to a method and an apparatus for detecting a reflection symmetry axis.

### 2. Description of the Related Art

Symmetry may be a fundamental concept common to both natural and artificial objects, and may be used to express morphological regularity and balance of objects. Symmetry may be used to simplify and efficiently represent the structure of objects in various fields such as architecture, industrial design, biology, and image recognition.

In image processing and computer vision, geometric approaches such as feature point matching or gradient analysis have been used to detect symmetric structures in objects or scenes, and schemes using frequency analysis or Hough transform have also been proposed. These approaches may be used to mathematically quantify reflectional or rotational symmetry patterns in images.

Recent advances in machine learning and deep learning have enabled neural networks to predict symmetric structures in images or perform self-similarity-based pattern analysis to detect symmetry. These technologies may be applied to various applications such as three-dimensional object recognition, autonomous driving, and medical image analysis as well as to two-dimensional images.

### SUMMARY

According to an aspect, there is provided an electronic device including at least one processor including processing circuitry, and memory storing instructions that, when executed by the at least one processor individually or collectively, cause the electronic device to extract an equivariant feature map by applying an equivariant backbone to an input image, generate a reflection similarity map by performing reflectional matching based on the equivariant feature map, predict initial parameters of a reflection axis based on the equivariant feature map and the reflection similarity map, and determine parameters of a reflection symmetry axis by performing orientational anchor expansion on the initial parameters.

The equivariant backbone may include equivariance with respect to a dihedral group.

The reflectional matching may measure a similarity between a feature fiber and a mirrored counterpart of the feature fiber based on a candidate reflection axis.

The reflectional matching may be performed to be equivariant under a dihedral group, and to be reflection-invariant with respect to a reflection transformation.

The reflectional matching may be performed based on a plurality of spatial scales to compare features within spatial neighborhoods.

The parameters of the reflection symmetry axis may include at least one of a midpoint probability, a length, or an orientation of a reflection axis represented by a geometric line.

The orientational anchor expansion may transform the initial parameters into the parameters of the reflection symmetry axis using a plurality of orientational anchors aligned with a group dimension of the equivariant feature map.

The orientational anchor expansion may include aggregating different rotation channels and reflection counterpart channels corresponding to the different rotation channels included in the initial parameters.

The aggregating of the reflection counterpart channels may include applying an addition operation to a midpoint parameter and a length parameter of the reflection symmetry axis, and applying a subtraction operation to an orientation parameter of the reflection symmetry axis.

The instructions, when executed by the at least one processor individually or collectively, may cause the electronic device to perform rotational matching to compare features at fixed angular intervals based on the equivariant feature map with respect to a candidate rotation center point, pool the equivariant feature map, and predict a rotational symmetry center represented by a geometric point, based on a result of the rotational matching and a result of the pooling.

The rotational matching may be performed to be invariant to both rotation and reflection transformations of a dihedral group.

The instructions, when executed by the at least one processor individually or collectively, may cause the electronic device to integrate symmetry information into the input image by combining one or more geometric lines corresponding to the determined parameters of the reflection symmetry axis and one or more geometric points corresponding to the predicted rotational symmetry center with the input image.

According to an aspect, there is provided a method of detecting a reflection symmetry axis, the method including extracting an equivariant feature map by applying an equivariant backbone to an input image, generating a reflection similarity map by performing reflectional matching based on the equivariant feature map, predicting initial parameters of a reflection axis based on the equivariant feature map and the reflection similarity map, and determining parameters of a reflection symmetry axis by performing orientational anchor expansion on the initial parameters.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic block diagram illustrating detection of a reflection symmetry axis, according to an embodiment.

FIG. 2 is a schematic flowchart illustrating a method of detecting a reflection symmetry axis, according to an embodiment.

FIG. 3 is a schematic block diagram illustrating reflectional matching and rotational matching, according to an embodiment.

FIG. 4 is a schematic block diagram illustrating orientational anchor expansion, according to an embodiment.

FIG. 5 is a schematic flowchart illustrating rotational matching according to an embodiment.

FIG. 6 is an exemplary diagram illustrating results of input transformation of a reflection symmetry axis detection system, according to an embodiment.

FIG. 7 is a block diagram of an electronic device according to an embodiment.

### DETAILED DESCRIPTION

The following structural or functional descriptions of embodiments are merely intended for the purpose of describing the embodiments, and the embodiments may be implemented in various forms. The embodiments are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, the “second” component may be referred to as the “first” component.

It will be understood that when a component is referred to as being “connected to” or “coupled” to another component, the component may be directly connected or coupled to the other component or intervening components may be present.

As used herein, the singular forms “a,” “an,” and “the” are intended to include the plural forms as well, unless the context clearly indicates otherwise. As used herein, the terms “include,” “comprise,” and “have” specify the presence of stated features, numbers, steps, operations, elements, components, and/or combinations thereof, but do not preclude the presence or addition of one or more other features, numbers, steps, operations, elements, components, and/or combinations thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

Reflection symmetry may refer to a property of an object's shape or structure in which corresponding parts form a mirrored relationship, and this symmetry may be widely found in both natural and artificial objects. Reflection symmetry may be used as an important clue to simplify shapes and understand structural regularities in various fields such as human visual perception, image processing, computer graphics, and pattern recognition.

As the complexity of image data increases, the demand for technology that automatically recognizes and analyzes symmetric information may increase. Accurately detecting a reflection symmetry axis may enable high-dimensional analysis such as object recognition or shape restoration based on the central structure or orientation of an object. For example, by finding a reflection symmetry axis in a facade of a building, a shape of a vehicle, or a structure of the human body, geometric relationships within a scene may be more clearly understood.

The embodiments to be described below relate to a method of automatically identifying an axis serving as a reference for reflection symmetry by analyzing a morphological pattern included in an image. The method of detecting the reflection symmetry axis may mathematically express symmetry by comprehensively considering morphological features of an image, and may estimate the existence and orientation of the reflection axis based on the results. The method may allow for recognition of consistent symmetric structures when an input image is rotated or reflected, and may enable stable detection of the reflection axis in complex scenes.

The method of detecting the reflection symmetry axis may clearly analyze structural characteristics of an image by expressing the reflection symmetry axis, and may be used in various application fields such as object recognition, scene restoration, image alignment, and three-dimensional (3D) shape analysis. Additionally, a reflection symmetry detection result may be applied to interpret a spatial relationship between image components or to subsequent processing based on geometric characteristics of an object.

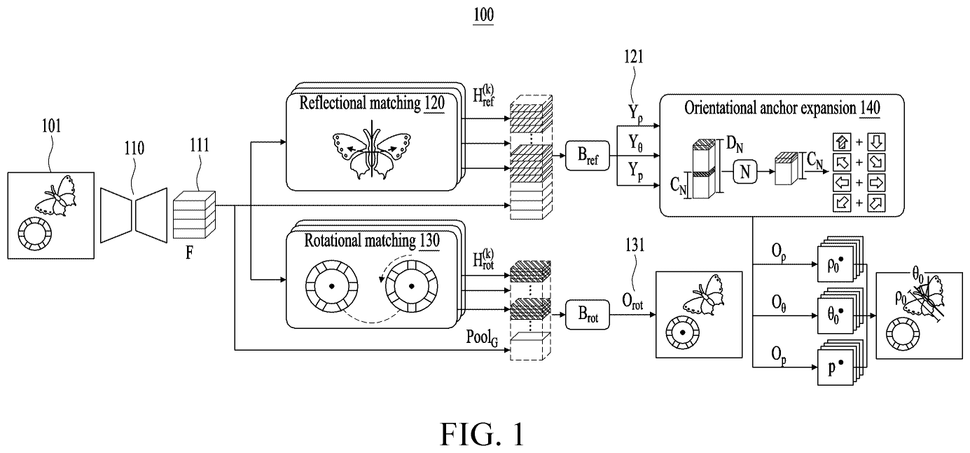

FIG. 1 is a schematic block diagram illustrating detection of a reflection symmetry axis according to an embodiment.

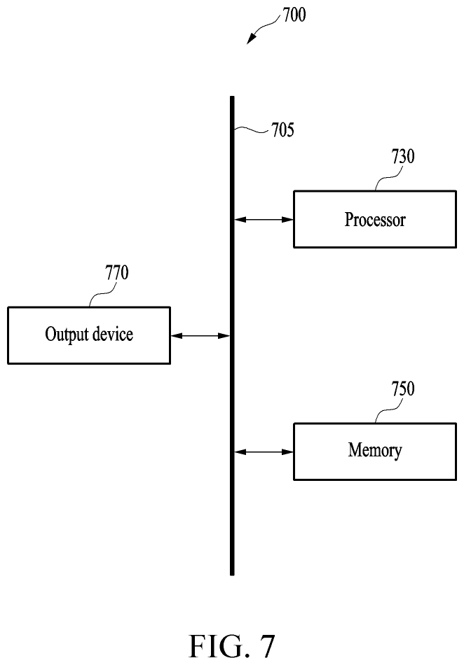

In FIG. 1, one or more blocks and a combination thereof may be implemented by a special-purpose hardware-based computer performing a predetermined function, or by a combination of computer instructions and special-purpose hardware. Hereinafter, an electronic device (e.g., an electronic device 700 of FIG. 7) according to an embodiment may also be referred to as a reflection symmetry axis detection system 100. The electronic device 700 may be a device that drives the reflection symmetry axis detection system 100.

The reflection symmetry axis detection system 100 according to an embodiment may be designed to detect a symmetric structure included in an input image 101 on an instance basis.

The embodiments described below relate to a method of detecting axis-level symmetry using a network equivariant to a dihedral group D_{N}. The method of detecting the reflection symmetry axis may model a reflection symmetry axis as a line segment and model a rotation symmetry axis as a point.

The network of the described embodiments may extract features from the input image 101 using an equivariant backbone 110 equivariant to the dihedral group D_{N}. The extracted features may be processed through two branches. A first branch may predict parameters such as a midpoint, orientation, and length of the reflection symmetry axis, and a second branch may predict a location and fold class of a rotational symmetry center.

The reflection symmetry axis detection system 100 may perform orientational anchor expansion 140 to process a plurality of orientation components. In this process, feature channels may be aligned to a discrete set of orientations of the dihedral group D_{N}, thereby maintaining a consistent feature representation for various orientations within an input image.

Additionally, the electronic device 700 may detect symmetry by performing reflectional matching 120 to compare features on both sides with respect to the reflection symmetry axis. The reflectional matching 120 may quantify symmetry strength by comparing an input feature with its mirrored feature. In addition, rotational matching 130 may detect rotational symmetry by comparing the same features at different rotation angles, while maintaining the equivariant property for the dihedral group D_{N}.

With this network structure, consistent symmetry detection may be achieved regardless of rotation or reflection transformation of the input image 101.

FIG. 1 schematically illustrates a configuration of the reflection symmetry axis detection system 100. The input image 101 may be input to the equivariant backbone 110, and feature representations equivariant to the dihedral group D_{N} may be extracted. The equivariant backbone 110 may generate an equivariant feature map 111 corresponding to a spatial resolution H×W of the input image 101 and a group level |D_{N}|, which may be expressed by Equation 1 below.

Referring to FIG. 1, the equivariant feature map 111 generated by the equivariant backbone 110 may be provided as an input to the reflectional matching 120 and the rotational matching 130.

According to an embodiment, the reflectional matching 120 may perform the equivariant reflectional matching based on the equivariant feature map 111, and as a result, a reflection similarity map

$$( see {H}_{ref}^{( k )} )$$

may be generated.

In response to generating the reflection similarity map, referring to [symbol] of FIG. 1, the electronic device 700 may receive the equivariant feature map 111 and the reflection similarity map as inputs and predict initial parameters Y_{ref} (e.g., Yₚ, Y_{ρ}, Y_{θ}) 121 of the reflection axis.

Thereafter, in the orientational anchor expansion 140, the initial parameters 121 may be received as an input and the reflection axis may be predicted. The reflection axis may be expressed in the form of a parameterized line segment including central coordinates (x, y), a length ρ, orientation θ, and midpoint probability p.

In an embodiment, the rotational matching 130 may represent the entire branch for rotational symmetry prediction. The rotational matching 130 may receive the equivariant feature map 111 as an input and perform two parallel operations internally. Rotational similarity features

$${H}_{r o t}^{( k )}$$

may be generated by performing invariant rotational matching on the equivariant feature map 111, and a pooled feature map may be generated by performing group pooling Pool^{G} on the equivariant feature map 111.

Thereafter, the rotational matching 130 may detect a rotational axis by concatenating the outputs (the rotational similarity features

$${H}_{r o t}^{( k )}$$

and pooled feature map) of the two parallel operations, and a fold class corresponding to each axis may be classified. Accordingly, the electronic device 700 may output a multi-class classification score map Oᵣₒₜ 131 through the rotational matching 130. The rotational axis may be parameterized as central coordinates (x, y) and a fold class probability pₛ.

The reflection symmetry axis detection system 100 according to FIG. 1 may independently process reflection symmetry and rotational symmetry in each branch based on the equivariant backbone 110 based on the dihedral group D_{N}, and may produce a stable symmetry detection result for rotation or reflection of the input image 101.

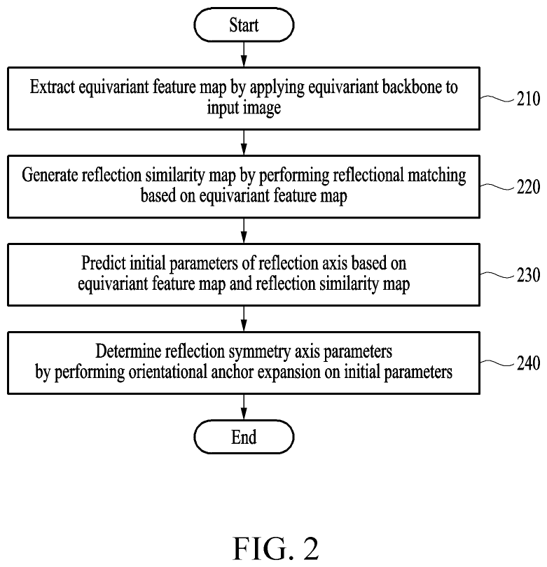

Hereinafter, the reflection symmetry axis detection system 100 of FIG. 1 is described in detail with reference to FIGS. 2 to 6.

FIG. 2 is a schematic flowchart illustrating a method of detecting a reflection symmetry axis, according to an embodiment.

Operations of FIG. 2 may be performed in the shown order and manner. However, the order of some operations may be changed, or some operations may be omitted, without departing from the spirit and scope of the shown example. Many of the operations illustrated in FIG. 2 may be performed in parallel or simultaneously.

In operation 210, the electronic device 700 may extract the equivariant feature map 111 by applying the equivariant backbone 110 to the input image 101.

According to an embodiment, a neural network model may extract the equivariant feature map F 111 from the input image I 101 using the equivariant backbone 110 equivariant to the dihedral group D_{N}. The equivariant feature map 111 may be expressed by Equation 1 below.

$$F ∈ {ℝ}^{H \times W \times C \vert {D}_{N} \vert} \qquad [ Equation 1 ]$$

Here, H and W denote spatial dimensions, |D_{N}|=2N denotes the number of elements in the dihedral group D_{N}, which is the sum of N rotations and its N reflections, and C denotes the number of channels per each group element. The equivariant feature map F may be passed on to branches for symmetry detection.

In an embodiment, the equivariant backbone 110 may include equivariance with respect to the dihedral group D_{N}.

According to an embodiment, a group may be a mathematical structure including a set and an operation, and may satisfy properties of closure, associativity, identity, and invertibility.

The group may define a transformation relationship that preserves the structure of an object by describing symmetry transformation such as rotation or reflection.

In an embodiment, a neural network-based equivariant structure may be defined based on such properties of a group. Representative discrete groups may be a cyclic group C_{N} and a dihedral group D_{N}. The described embodiments may implement equivariance with respect to rotation and reflection using the dihedral group D_{N}. The cyclic group C_{N} may represent a discrete rotational transformation, and elements may be expressed as r⁰, r¹, . . . , r^{N-1}. The associative law of the group may be defined as rⁱr^{j}=r^{(i+j)mod N}.

The dihedral group D_{N} may include a reflection transformation in addition to the rotation of the cyclic group, and elements may be defined as expressed by Equation 2 below.

$${D}_{N} = {r}^{0} , {r}^{1} , … , {r}^{N - 1} , b , br , {br}^{2} , … , {br}^{N - 1} \qquad [ Equation 2 ]$$

Here, r denotes a generator for generating rotations and b denotes a generator for generating reflections. The dihedral group D_{N} referred to by the equivariant backbone 110 may be a discrete group including both rotation transformations and reflection transformations.

r may be a generator of rotation and b may be a generator of reflection, and each generator may satisfy a relational expression such as Equation 3 below.

$${b}^{2} = e and {r}^{n} b = b {r}^{- n} \qquad [ Equation 3 ]$$

Here, e denotes an identity element.

In an embodiment, the equivariant backbone 110 may use regular representation to encode group actions. The regular representation may allow operations of a group to be linearly applied to a feature space by representing each group element as a permutation matrix that operates on a vector space.

Accordingly, a convolution for each group element may generate a feature map identically reflecting a corresponding transformation result of the input image 101.

Equivariance may be established when a function ƒ:X→Y commutes with a group action. For example, equivariance may be established when two representations σ₁: G→GL(X) and σ₂: G→GL(Y) in group G satisfy the relationship in Equation 4 below.

$$f ( {σ}_{1} ( g ) \cdot x ) = {σ}_{2} ( g ) \cdot f ( x ) , ∀ g ∈ G , x ∈ X \qquad [ Equation 4 ]$$

The relationship in Equation 4 may ensure that a group transformation for an input space corresponds to a predictable transformation in an output space. Accordingly, equivariance in a neural network structure may maintain the symmetry of data by ensuring that transformations to the input are reflected in the output in the same manner.

For example, when the input image 101 is rotated or reflected, an output feature map of the equivariant backbone 110 may be maintained in a form transformed into a corresponding rotation or reflection state. Therefore, the equivariant backbone 110 may provide a predictable response to geometric transformations of the input image 101 thereby generating the equivariant feature map 111 that reliably represents the structural pattern included in the input image 101.

The equivariant backbone 110 may provide a basic representation for detecting a symmetric structure in the reflectional matching 120 and the rotational matching 130 performed in subsequent operations by outputting the equivariant feature map 111.

In operation 220, the electronic device 700 may generate a reflection similarity map by performing the reflectional matching 120 based on the equivariant feature map 111.

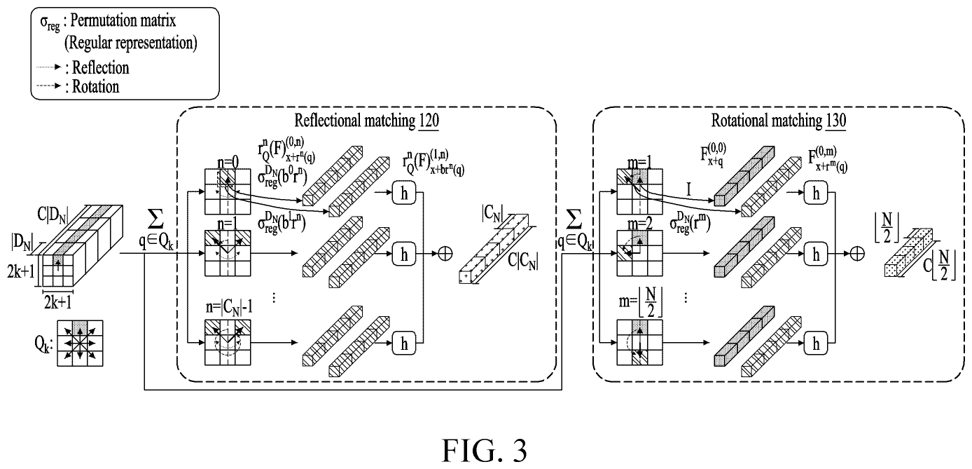

According to an embodiment, the reflectional matching 120 may be measuring a similarity between a feature fiber and a mirrored counterpart of the feature fiber based on a candidate reflection axis (as described in detail below with reference to FIG. 3).

According to an embodiment, the reflectional matching 120 may be performed to be equivariant under the dihedral group and reflection-invariant with respect to a reflection transformation. That is, the reflectional matching 120 may be performed to be equivariant under the dihedral group D_{N} while maintaining reflection-invariance with respect to reflection transformation.

According to an embodiment, the reflectional matching 120 may be performed based on a plurality of spatial scales to compare features within spatial neighborhoods. Additionally, the electronic device 700 may calculate a reflection similarity based on a plurality of spatial scales to compare features within spatial neighborhoods. Through this process, the reflection similarity map may capture symmetry at multiple scales of the input image 101 and may be used as a basis for calculating initial and final values of reflection axis parameters in subsequent operations.

According to an embodiment, the electronic device 700 may generate a reflection similarity map

$${H}_{ref}^{( k )}$$

as the result of the reflectional matching 120. A reflection similarity map may be a disparity strength representation obtained by calculating a similarity between a feature fiber and its mirrored counterpart corresponding to each rotational orientation component of the equivariant feature map 111. That is, the reflection similarity map may function as a similarity field that quantitatively indicates how reflectively symmetrical each location of the input image is.

In this way, the reflection similarity map may be used as an input for estimating the initial parameters 121 of the reflection axis in a subsequent operation, and may provide basic data for comprehensively calculating orientation, length, and midpoint probability of the reflection axis.

In operation 230, the electronic device 700 may predict the initial parameters 121 of the reflection axis based on the equivariant feature map F 111 and the reflection similarity map.

According to an embodiment, the electronic device 700 may estimate the initial parameters 121 of the reflection axis by concatenating orientation information extracted from the equivariant feature map F 111 and similarity strength computed from the reflection similarity map

$${H}_{ref}^{( k )} .$$

According to an embodiment, a reflection branch [symbol] predicting the initial parameters 121 may receive the concatenated features as an input to output the initial parameters Y_{ref} 121 expressed by Equation 5 below.

$${Y}_{ref} = [ {Y}_{p} , {Y}_{P} , {Y}_{θ} ] ∈ {R}^{\vert {D}_{N} \vert \times H \times W \times 3} \qquad [ Equation 5 ]$$

Here, Yₚ denotes the probability that each spatial location is a midpoint of the reflection axis, and Y_{ρ} and Y_{θ} may provide regression outputs for a length and orientation of the axes, respectively, across a group dimension of |D_{N}|.

The initial parameters Y_{ref} 121 predicted in this manner may be initial parameters of the reflection axis, which may be used as an input to derive final reflection symmetry axis parameters through the orientational anchor expansion 140 in the subsequent operation 240.

A further description of the reflectional matching 120 of operations 220 and 230 is provided below with reference to FIG. 3.

In operation 240, the electronic device 700 may determine reflection symmetry axis parameters O_{ref} by performing the orientational anchor expansion 140 on the initial parameters Y_{ref} 121.

According to an embodiment, the orientational anchor expansion 140 may transform the initial parameters 121 into reflection symmetry axis parameters using a plurality of orientational anchors aligned with a group dimension of the equivariant feature map 111. The orientational anchor expansion 140 may be designed to use the group dimension of |D_{N}| of the initial parameters Y_{ref} 121. The electronic device 700 may transform the initial parameters Y_{ref} 121 into the final reflection symmetry axis parameters O_{ref} using a plurality of orientational anchors aligned with the group dimension of the dihedral group D_{N}.

According to an embodiment, the orientational anchor expansion 140 may include aggregating different rotation channels and their corresponding reflection counterpart channels included in the initial parameters 121. The orientational anchor expansion 140 may include aggregating different rotation channels (e.g., rⁱ) and their corresponding reflection counterpart channels (e.g., brⁱ) included in the initial parameters Y_{ref} 121. Each rotation channel may represent a feature corresponding to a predetermined direction, and the reflection counterpart channel may represent a reflection corresponding component in that direction. The electronic device 700 may comprehensively correct the midpoint, length, and orientation of the reflection axis using the correspondence between these two channels.

In an embodiment, aggregating the reflection counterpart channels may include applying an addition operation to a midpoint parameter and a length parameter of the reflection symmetry axis, and applying a subtraction operation to an orientation parameter of the reflection symmetry axis. This process may allow to transform parameters computed independently for each orientation anchor into a unified axis representation while maintaining a consistent symmetric representation for rotation and reflection transformations. For example, the aggregating of the reflection counterpart channels may apply different operations depending on the characteristics of the parameters. Specifically, an addition operation may be applied to a midpoint probability Yₚ and length Y_{ρ} parameter of the reflection symmetry axis (since the midpoint probability and length are invariant to reflection), and a subtraction operation may be applied to an orientation Y_{θ} parameter of the reflection symmetry axis (since a sign is inverted upon reflection). According to an embodiment, the electronic device 700 may combine responses of a predetermined orientation channel α and its opposite orientation channel α+N/2 to generate the final reflection symmetry axis parameters O_{ref} in order to resolve ambiguity (i.e., representing the same physical axis) of θ and θ+π with respect to the aggregated features.

According to an embodiment, the reflection symmetry axis parameters may include at least one of a midpoint probability, a length, or an orientation of a reflection axis represented by a geometric line. As a result, the electronic device 700 may secure direction consistency for the initial reflection axis candidate and produce more stable reflection symmetry axis parameters.

FIG. 3 is a schematic block diagram illustrating reflectional matching and rotational matching, according to an embodiment.

The description provided with reference to FIGS. 1 and 2 may apply to FIG. 3, and any repeated description related thereto may be omitted.

Referring to FIG. 3, the reflectional matching 120 may verify the reflection symmetry of a pattern by comparing a feature fiber with its mirrored counterpart. That is, the reflectional matching 120 may be performed as a process of quantitatively calculating whether an area within the input image 101 has a similar structure for reflection transformation.

The electronic device 700 according to an embodiment may perform the reflectional matching 120 using a feature map that is equivariant to the dihedral group D_{N}. The D_{N}-equivariant feature may provide a robust basis for symmetry detection that may quantitatively express reflection symmetry.

According to an embodiment, when given a single feature fiber f∈ [symbol] , which corresponds to a feature vector across channel dimensions at a specific spatial location (x, y), from the equivariant feature map 111 F∈ [symbol] , its reflected and rotated transformed form f^{(l,n)} may be defined as in Equation 6 below.

$${f}^{( l , n )} = {⊕}_{c = 1}^{𝒞} {σ}_{reg}^{{D}_{N}} ( {b}^{l} {r}^{n} ) {f}_{c} ∈ {ℝ}^{𝒞 \vert {D}_{N} \vert} \qquad [ Equation 6 ]$$

Here, f_{c}∈ [symbol] denotes a group equivariant part of the feature fiber, which may be expressed as

$$f = {[ {f}_{1}^{T} , {f}_{2}^{T} , … , {f}_{𝒞}^{T} ]}^{T} .$$

In addition,

$${σ}_{reg}^{{D}_{N}} ( {b}^{l} {r}^{n} )$$

denotes a regular representation of D_{N} corresponding to l reflections and n rotations.

In an embodiment, a group-aware similarity h between two feature fibers f¹, f² ∈ [symbol] may be defined as in Equation 7 below.

$$h ( {f}^{1} , {f}^{2} ) = {{⊕}_{c = 1}}^{𝒞} \frac{{f}_{c}^{1} \cdot {f}_{c}^{2}}{‖ {f}_{c}^{1} ‖ ‖ {f}_{c}^{2} ‖} ∈ {ℝ}^{𝒞} \qquad [ Equation 7 ]$$

h(⋅) according to Equation 7 may measure the directional correspondence and group equivariant similarity between the two feature fibers by calculating a normalized dot product for each channel unit.

In an embodiment, the reflectional matching 120 may be performed by comparing a similarity between a rotated feature fiber and a reflection-rotated feature fiber for all rotation angles. For example, a reflection similarity H_{ref,x} in each location x may be defined as in Equation 8 below.

$${H}_{ref , x} = {{⊕}_{n = 0}}^{\vert {C}_{N} \vert - 1} h ( {F}_{x}^{( 0 , n )} , {F}_{x}^{( 1 , n )} ) ∈ {ℝ}^{𝒞 \vert {C}_{N} \vert} \qquad [ Equation 8 ]$$

Here,

$${F}_{x}^{( 0 , n )} and {F}_{x}^{( 1 , n )}$$

denote a feature fiber without and with reflection applied after n rotations, respectively. A similarity score map H∈ [symbol] produced in this manner may preserve reflection-invariance while maintaining equivariance to the dihedral group D_{N}.

According to an embodiment, the reflectional matching 120 may detect symmetry at a spatial neighborhood level as well as symmetry at a single location. For this purpose, the electronic device 700 may define a two-dimensional neighbor set Qₖ based on a midpoint as in Equation 9 below.

$${Q}_{k} = ( i , j ) \vert i , j ∈ [ - k , k ] \qquad [ Equation 9 ]$$

Here, k∈ [symbol] denotes the size of a neighborhood and Qₖ denotes a spatial extent around a midpoint.

According to an embodiment, the electronic device 700 may apply rotation and reflection operations to a plurality of locations included in the neighborhood set Qₖ based on a midpoint x to evaluate the reflection symmetry at the spatial neighborhood level. Accordingly, a reflection similarity map

$${H}_{ref , x}^{( k )}$$

at the neighborhood level may be calculated as shown in Equation 10 below.

$${H}_{ref , x}^{( k )} = {\sum }_{q ∈ {Q}_{k}} {{⊕}_{n = 0}}^{\vert {C}_{N} \vert - 1} h ( {{r}_{Q}^{n} ( F )}_{x + {r}^{n} ( q )}^{( 0 , n )} , {{r}_{Q}^{n} ( F )}_{x + {br}^{n} ( q )}^{( 1 , n )} ) ∈ {ℝ}^{𝒞 \vert {C}_{N} \vert} \qquad [ Equation 10 ]$$

Here, b^{l}rⁿ(q) denotes an offset defined by transformation after n rotations and l reflections, and

$${r}_{Q}^{n}$$

denotes an operation that rotates the entire neighborhood set Q n times around the midpoint. That is, the electronic device 700 may evaluate reflective symmetry strength of the entire neighborhood by calculating the similarity h(⋅) between equivariant features for pairs of rotated-reflected neighboring locations.

According to an embodiment, the electronic device 700 may perform an operation of the same form as Equation 10 on a plurality of spatial scales k₁, k₂, . . . , k_{M} to improve robustness of the calculation. Reflection similarity features

$${H}_{ref}^{( {k}_{1} )} , … , {H}_{ref}^{( {k}_{M} )}$$

corresponding to each scale may be concatenated with the basic equivariant feature map F 111 to simultaneously capture reflection symmetry at various spatial resolutions.

An output of the reflectional matching 120 calculated in this manner may be equivariant to the dihedral group D_{N} while preserving reflection-invariance under reflection transformations. Accordingly, the electronic device 700 may output the same reflection similarity response when rotation and reflection transformations are arbitrarily applied, thereby stably detecting various types of symmetric structures within an input image.

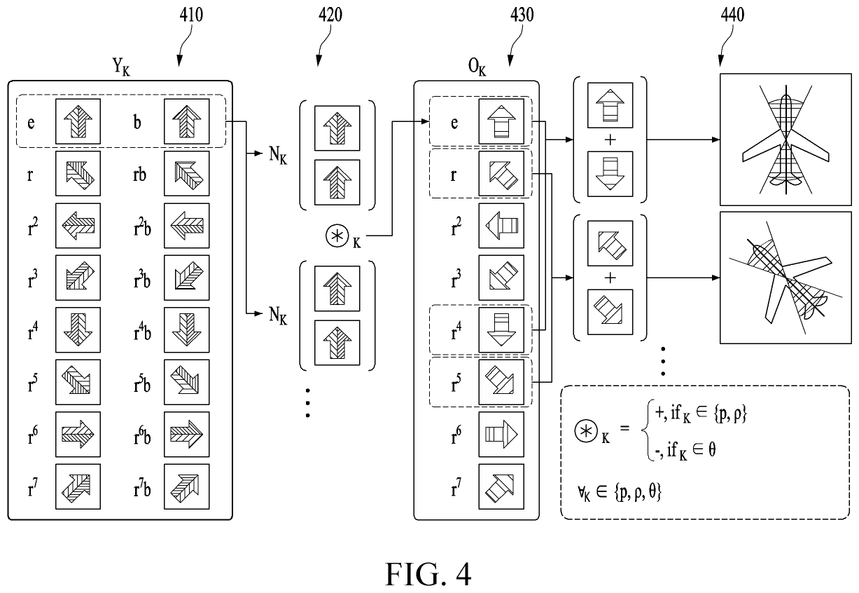

FIG. 4 is a schematic block diagram illustrating the orientational anchor expansion 140 according to an embodiment.

The description provided with reference to FIGS. 1 to 3 may apply to FIG. 4, and any repeated description related thereto may be omitted.

Referring to FIG. 4, the orientational anchor expansion 140 may be a process for transforming the initial parameters 121 of a reflection axis output from a reflection branch into final reflection symmetry axis parameters using a plurality of orientational anchors aligned with the group dimension.

According to an embodiment, the electronic device 700 may acquire a reflective component map Yₖ 410 corresponding to each group dimension from a dihedral group D_{N}-equivariant feature map. Here, κ∈p, ρ, θ denote a midpoint probability, a length and an angle of the axis, respectively.

Y_{κ} may have 2N group dimensions, each dimension corresponding to a predetermined rotation component rⁱ and its corresponding reflection component brⁱ. In other words, a (i, i+N) pair may include a forward rotation response and its reflection response for the same rotation angle. The reflective component map Y_{κ} 410 may represent an example in which feature responses of each of these rotation and reflection pairs are arranged in matrix form.

According to an embodiment, the electronic device 700 may aggregate, into a single response, reflection counterpart pairs corresponding to each rotation channel rⁱ and reflection channel brⁱ within the reflective component map Y_{κ} 410. Through this process, the electronic device 700 may eliminate redundant expressions due to reflection transformation and maintain pure equivariant features that only consider rotation.

Reflection counterpart aggregation 420 may be an operation process [symbol] for integrating reflection counterpart pairs. [symbol] may be defined as a transformation operator to learn and reweight useful information between each channel pair, rather than a simple addition or subtraction.

According to an embodiment, the electronic device 700 may perform an aggregation operation by distinguishing between components, which have signs that do not change due to reflection, and components, which have signs that change due to reflection. For example, the midpoint probability Yₚ and length Y_{ρ} of the reflection symmetry axis may not change in value depending on whether it is reflected or not, so the electronic device 700 may add the two responses together and aggregate them. On the other hand, an orientation component Y_{θ} may have a characteristic that a sign is reversed when reflected θ→−θ, so the electronic device 700 may reflect the corresponding reflection responses by subtracting them from each other.

More specifically, when a feature map for each rotation channel i is

$${Y}_{κ}^{( i )} ,$$

and the corresponding reflection channel is

$${Y}_{κ}^{( i + N )} ,$$

the electronic device 700 may calculate an integrated aggregate feature \tilde{Y}_{κ} for N rotation directions, based on a pair of the two channels. Accordingly, feature information about the midpoint probability, length, and orientation of the reflection axis may be integrated while preserving reflection-invariance and maintaining the correspondence between each orientation pair. The aggregate feature \tilde{Y}_{κ}0 may be expressed by Equation 11 below.

$${\tilde{Y}}_{κ} = {{⊕}_{i = 1}}^{\vert {C}_{N} \vert} [ {𝒩}_{κ} ( [ {Y}_{κ}^{( i )} ; {Y}_{κ}^{( i + N )} ] ) {κ}_{} {𝒩}_{κ} ( [ {Y}_{κ}^{( i + N )} ; {Y}_{κ}^{( i )} ] ) ] \qquad [ Equation 11 ]$$

Here, ⊗_{κ} denotes a component-wise combination operation, and depending on a type of κ, [symbol] =+ for κ∈p, ρ or [symbol] =− for κ=θ may be satisfied.

That is, an addition operation may be performed on the midpoint probability p and the length ρ, and a subtraction operation may be applied to the orientation θ since the sign is inverted upon reflection. Therefore, a process of integrating the reflection counterpart pairs for each orientation component may be confirmed through the learned transformation [symbol] .

In an embodiment, ambiguity regarding the orientation representation may exist even after the reflection counterparts are merged in orientational anchor generation 430. That is, a line for orientation θ may represent the same physical axis as a line for orientation θ+π, and the two orientations may be considered to refer to the same symmetry axis.

Accordingly, in order to remove the ambiguity described above, the electronic device 700 may generate a single orientational anchor output by combining an aggregate response at a rotation channel index α with a response at a corresponding channel index α+N/2. A parameter set O_{ref}=[Oₚ; O_{ρ}; O_{θ}]∈ [symbol] of the reflection symmetry axis may be expressed by Equation 12 below.

$${O}_{κ , α} = {\tilde{Y}}_{κ , α} + {\tilde{Y}}_{κ , α + N / 2} , α = 1 , … , \frac{N}{2} , \qquad [ Equation 12 ]$$

Here, κ∈p, ρ, θ0 denote the midpoint probability, length, and orientation of the reflection axis, respectively. Each orientational anchor O_{α} configured in this manner may be trained to detect a reflection axis having an orientational offset within a range

$$[ - \frac{π}{N} , \frac{π}{N} )$$

from a reference orientation

$$\frac{2 π α}{N} .$$

According to an embodiment, the electronic device 700 may maintain invariant regression values between different orientational anchors by predicting an offset from a reference orientation in place of directly regressing to an absolute orientation. In this way, the electronic device 700 may adaptively estimate the orientation for each orientational anchor while preserving invariance with respect to the rotational direction.

The reflection axis for each location (α, x, y) may be expressed as (α, x, y, p, ρ, θ), and an output O_{(α,x,y)}=(p, ρ, θ) may determine start and end points of the axis as in Equations 13 and 14 below.

$$[ \begin{matrix}{x}_{s , α} \\ {y}_{s , α}\end{matrix} ] = [ \begin{matrix}{x}_{α} \\ {y}_{α}\end{matrix} ] + \frac{ρ}{2} [ \begin{matrix}cos ( {θ}_{α} ) \\ sin ( {θ}_{α} )\end{matrix} ] \qquad [ Equation 13 ]$$

$$[ \begin{matrix}{x}_{e , α} \\ {y}_{e , α}\end{matrix} ] = [ \begin{matrix}{x}_{α} \\ {y}_{α}\end{matrix} ] - \frac{ρ}{2} [ \begin{matrix}cos ( {θ}_{α} ) \\ sin ( {θ}_{α} )\end{matrix} ] \qquad [ Equation 14 ]$$

Here,

$${θ}_{α} = \frac{2 π α}{N} + θ$$

denotes the absolute orientation of each anchor. By explicitly expressing the midpoint coordinates, length, and orientation of an axis corresponding to each orientation channel α, the electronic device 700 may calculate geometric line segments of the reflection symmetry axis while maintaining equivariance with respect to rotation and reflection transformations.

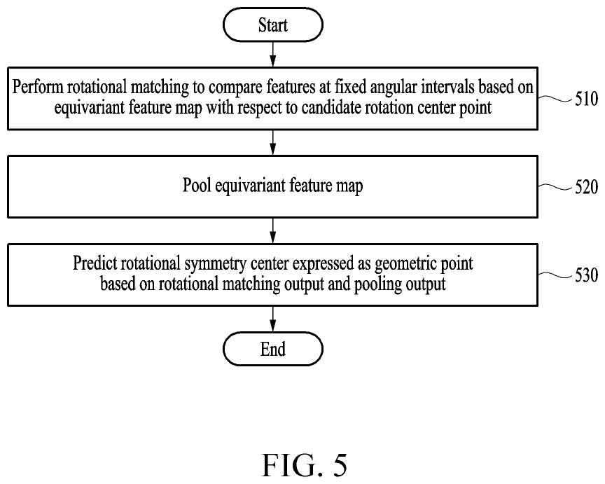

Hereinafter, the rotational matching 130 is described in detail with reference to FIG. 5.

FIG. 5 is a schematic flowchart illustrating rotational matching according to an embodiment.

The description provided with reference to FIGS. 1 to 4 may apply to FIG. 5, and any repeated description related thereto may be omitted.

In operation 510, the electronic device 700 may perform the rotational matching 130 to compare features at fixed angular intervals based on the equivariant feature map 111 with respect to a candidate rotation center point.

According to an embodiment, the rotational matching 130 may be performed to be invariant to both rotational and reflection transformations of a dihedral group.

In an embodiment, rotation symmetry may be determined by comparing whether a predetermined pattern remains the same as an original pattern when rotated about its axis. The electronic device 700 may calculate a similarity by comparing a feature vector for each candidate center point with a feature vector rotated around the center.

According to an embodiment, n-fold rotational symmetry may have properties that are invariant to rotation in the unit of 2π/n. Therefore, the electronic device 700 may reduce redundancy of comparison operations by using consistency of feature comparisons at fixed angular intervals without comparing all possible rotation feature pairs. According to an embodiment, the electronic device 700 may use the consistency of feature comparisons at fixed angular intervals to reduce redundancy in similarity comparisons, and perform only unique comparisons

$$⌊ \frac{N}{2} ⌋$$

in place of performing all feature pair _{N}C₂ comparisons. Accordingly, a feature of the rotational matching 130 may be calculated as follows. The feature of the rotational matching 130 may be calculated as shown in Equation 15 below.

$${H}_{rot , x} = {⊕}_{m = 1}^{⌊ \frac{N}{2} ⌋} h ( {F}_{x}^{( 0 , 0 )} , {F}_{x}^{( 0 , m )} ) ∈ \qquad [ Equation 15 ]$$

Here,

$${F}_{x}^{( 0 , 0 )}$$

denotes a reference feature at a location x,

$${F}_{x}^{( 0 , m )}$$

denotes an mth rotated feature, and h(⋅) may be a function that calculates a similarity between two features. H_{rot,x} computed from Equation 15 may be a feature of the rotational matching 130 that maintains dihedral group-invariance with respect to rotation and reflection transformations.

The electronic device 700 may perform an operation to aggregate features at multiple locations to extend results of the rotational matching 130 to a spatial neighborhood. For example, for a neighborhood set [symbol] around the location x, a spatial feature of the rotational matching may be calculated as shown in Equation 16 below.

$${H}_{rot , x}^{( k )} = {\sum }_{qϵ {Q}_{k}} {⊕}_{m = 1}^{⌊ \frac{N}{2} ⌋} h ( {F}_{x + q}^{( 0 , 0 )} , {F}_{x + {r}^{m} ( q )}^{( 0 , m )} ) ∈ \qquad [ Equation 16 ]$$

Here,

$${F}_{x + q}^{( 0 , 0 )}$$

denotes a reference feature at a spatial location x+q, and

$${F}_{x + {r}^{m} ( q )}^{( 0 , m )}$$

denotes a feature of a transformed neighborhood location after the mth rotation. Through this equation, a neighborhood rotational similarity that locally considers a rotational relationship around each center point may be calculated.

In operation 520, the electronic device 700 may pool the equivariant feature map 111. Group pooling may be an operation that aggregates features across group dimensions of |D_{N}| of the equivariant feature map F 111. Through the group pooling, the pooled equivariant feature map Pool_{G}(F) 111 invariant to rotation and reflection transformations may be generated.

The pooled equivariant feature map 111 generated in this manner may be used as an input for predicting a final rotational symmetry center in a subsequent operation 530, together with the output of the rotational matching 130.

In operation 530, the electronic device 700 may predict a rotational symmetry center expressed as a geometric point, based on the output of the pooling and the output of the rotational matching 130.

According to an embodiment, the electronic device 700 may detect an accurate rotation axis and fold class by concatenating multi-scale rotational similarity features produced by the rotational matching 130 with the pooled equivariant feature map 111.

In an embodiment, a rotation branch [symbol] that receives the concatenated features as an input may output the multi-class classification score map 131 Oᵣₒₜ for predicting the presence of a rotation axis and fold class, which may be expressed by Equation 17 below.

$${O}_{r o t} = ( {Pool}_{G} ( F ) ⊕ {H}_{r o t}^{( k )} ) \qquad [ Equation 17 ]$$

Here, S denotes the number of fold classes including a background class. The rotation axis prediction at each location (x, y) of the Oᵣₒₜ map produced in this manner may be expressed as (x, y, pₛ), and pₛ denotes the probability for a sth fold class.

The concatenated output may estimate a location of an actual rotation center point by using multi-scale feature information while maintaining invariance under both rotation and reflection transformations.

In order to optimize the parameters of the reflection symmetry axis detection system 100 described with reference to FIGS. 1 to 5, i.e., the neural network architecture, the electronic device 700 may train the neural network using an objective function including a plurality of loss terms.

In an embodiment, the overall training objective may include both reflection symmetry loss and rotational symmetry loss.

i) Reflection symmetry loss: to learn reflection symmetry, the electronic device 700 may apply the following three losses: (a) midpoint classification loss, (b) length regression loss, and (c) orientation regression loss.

In an embodiment, the (a) midpoint classification loss [symbol] may be used to classify whether each location is the midpoint of the actual reflection axis or not, and may be optimized using weighted binary cross-entropy as shown Equation 18 below.

$${ℒ}_{p} = {E}_{( x , y )} [ - {γ}_{ref} p log ( \hat{p} ) - ( 1 - p ) log ( 1 - \hat{p} ) ] \qquad [ Equation 18 ]$$

Here, p denotes a ground truth label, and \hat{p} denotes a probability predicted by the neural network. Y_{ref} may be a weighting factor to resolve class imbalance.

In an embodiment, the (b) length regression loss [symbol] and (c) orientation regression loss [symbol] may only be applied to an actual midpoint location p=1. This may be implemented through an indicator function [symbol] , and may be defined by Equations 19 and 20 below, respectively.

$${ℒ}_{ρ} = {( x , y )}_{} [ \cdot SmoothL 1 ( ρ , \hat{ρ} ) ] \qquad [ Equation 19 ]$$

$${ℒ}_{θ} = {( x , y )}_{} [ \cdot \vert θ - \hat{θ} \vert ] \qquad [ Equation 20 ]$$

Here, ρ and θ denote ground truth values of length and orientation, respectively, and \hat{ρ} and \hat{θ} denote values predicted by the neural network. Using the indicator function [symbol] may increase stability of learning by preventing the neural network from learning to regress length and orientation for background pixels that are not the actual symmetry axis.

ii) Rotational symmetry loss: to learn rotational symmetry, the electronic device 700 may apply fold classification loss [symbol] . The loss may be optimized using weighted multi-class cross-entropy as shown in Equation 21 below.

$${ℒ}_{f o l d} = {( x , y , s )}_{} [ - {γ}_{r o t} {p}_{s} log {\hat{p}}_{s} ] \qquad [ Equation 21 ]$$

Here, s denotes the fold class, and γᵣₒₜ denotes a weighting factor applied to the location p=1 where the actual rotation axis exists.

iii) Total Loss: total loss [symbol] for training the neural network may be defined as a weighted sum of the individual loss terms described above, which may be expressed by Equation 22 below.

$${ℒ}_{total} = {ℒ}_{p} + {λ}_{ρ} {ℒ}_{ρ} + {λ}_{θ} {ℒ}_{{θ}^{+}} {λ}_{fold} {ℒ}_{fold} \qquad [ Equation 22 ]$$

Here, λ_{ρ}, λ_{θ}, and λ_{fold} denote weighting coefficients to balance the overall learning by adjusting the importance or scale of each loss term. The electronic device 700 may perform learning by updating the parameters of the neural network in a direction that minimizes the [symbol] .

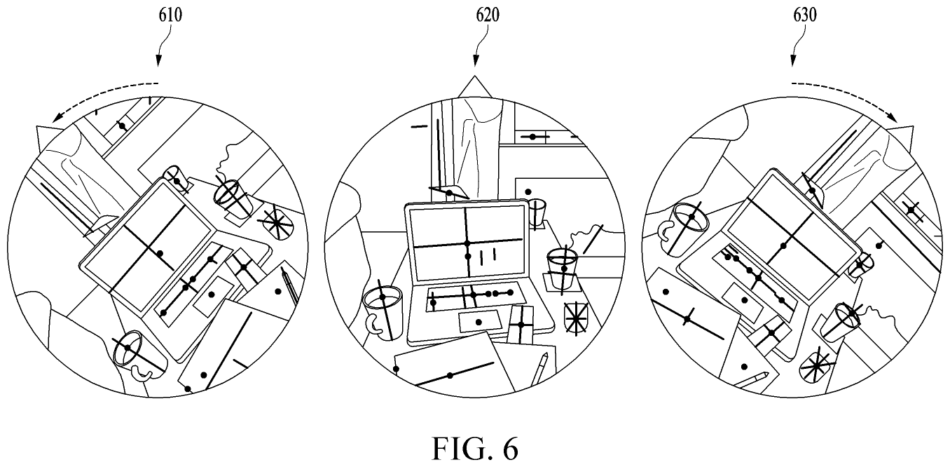

FIG. 6 is a diagram illustrating results of input transformation of a reflection symmetry axis detection system, according to an embodiment.

As described in detail with reference to FIGS. 1 to 5, the reflection symmetry axis detection system 100 may be based on the equivariant backbone 110 that is equivariant to the dihedral group D_{N}.

As defined in Equation 4 above, equivariance may be the property that when a transformation such as rotation is applied to the input image 101, an output ƒ(x) is also transformed σ₂(g)·ƒ(x) in the same manner corresponding to the transformation of the input. FIG. 6 may visually illustrate the changes due to this equivariant property.

A second image 620 may be a result of performing symmetry detection on the original input image (e.g., the input image 101) (0° rotation). It may be seen that a reflection symmetry axis and rotational symmetry center are accurately detected for various objects such as laptop screens, keyboards, and mugs.

A first image 610 may be a detection result when the same input image 101 is rotated counterclockwise (e.g., −45° rotation).

A third image 630 may be a detection result when the same input image 101 is rotated clockwise (e.g., +45° rotation).

As may be clearly seen in the first image 610 and the third image 630, even though the input image 101 itself is rotated, the reflection symmetry axis detection system 100 may output results in which the detected symmetry axes are also rotated in response to the rotation of the input. That is, the symmetry axes may still maintain their corresponding locations and orientations with respect to the rotated objects.

Therefore, the reflection symmetry axis detection system 100 may be very robust to changes in the orientation of the input image 101 and may provide consistent symmetry detection performance for rotational transformation.

The electronic device 700 according to an embodiment may integrate symmetry information into the input image 101 by combining one or more geometric lines corresponding to determined reflection symmetry axis parameters and one or more geometric points corresponding to predicted rotational symmetry centers with the input image 101.

The electronic device 700 according to an embodiment may integrate the detected symmetry information with the original input image 101 using the final determined reflection symmetry axis parameters O_{ref} and the predicted rotational symmetry center Oᵣₒₜ.

Specifically, the electronic device 700 may render one or more geometric lines based on start points xₛ, yₛ and end points xₑ, yₑ of the reflection symmetry axis calculated by referring to Equations 13 and 14. In addition, the electronic device 700 may render one or more geometric points corresponding to locations x, y of the rotational symmetry center predicted in Equation 17 and the classified fold class pₛ.

The electronic device 700 according to an embodiment may generate an output image in which symmetry information is visualized, such as the first image 610, the second image 620, and the third image 630, by overlaying geometric lines and points rendered in this manner onto the original input image 101. The output images generated in this manner may intuitively provide detection results to a user, or may be used as input data for subsequent computer vision tasks such as scene understanding, object alignment, or 3D reconstruction.

FIG. 7 is a block diagram of an electronic device according to an embodiment.

The description provided with reference to FIGS. 1 to 6 may apply to FIG. 7, and any repeated description related thereto may be omitted.

Referring to FIG. 7, the electronic device 700 may include a processor 730, a memory 750, and an output device 770 (e.g., a display). The processor 730, the memory 750, and the output device 770 may be connected to each other via a communication bus 705. The electronic device 700 may include the processor 730 for performing at least one method described above or an algorithm corresponding to the at least one method, for operating the electronic device 700.

The output device 770 may display a user interface for the reflection symmetry axis detection system 100 to the processor 730. The output device 770 may be the same device as a display included in the electronic device 700. Additionally, the output device 770 may be embedded in the electronic device 700 to display the user interface or may be an external display device.

The memory 750 may store data related to the method of detecting the reflection symmetry axis, performed by the processor 730. In addition, the memory 750 may store various pieces of information generated in the processing of the processor 730 described above. In addition, the memory 750 may store various types of data and programs. The memory 750 may include a volatile memory or a non-volatile memory. The memory 750 may store a variety of data by including a large mass storage medium, such as a hard disk.

In addition, the processor 730 may perform at least one of the methods described with reference to FIGS. 1 to 6 or an algorithm corresponding to at least one of the methods. In the above-described process, the processor 730 may be a hardware-implemented data processing device having a circuit that is physically structured to execute desired operations. For example, the desired operations may include code or instructions included in a program. The processor 730 may be implemented as, for example, a central processing unit (CPU), a graphics processing unit (GPU), or a neural processing unit (NPU). The electronic device 700, which is implemented by hardware, may include, for example, a microprocessor, a CPU, a processor core, a multi-core processor, a multiprocessor, an application-specific integrated circuit (ASIC), and a field-programmable gate array (FPGA).

The processor 730 may execute a program and control the electronic device 700. Code of the program to be executed by the processor 730 may be stored in the memory 750.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, control, process, and create data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording media.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape: optical media such as CD-ROM discs and DVDs: magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. An electronic device, comprising:
at least one processor including processing circuitry; and
memory storing instructions that, when executed by the at least one processor individually or collectively, cause the electronic device to:
extract an equivariant feature map by applying an equivariant backbone to an input image;
generate a reflection similarity map by performing reflectional matching based on the equivariant feature map;
predict initial parameters of a reflection axis based on the equivariant feature map and the reflection similarity map; and
determine parameters of a reflection symmetry axis by performing orientational anchor expansion on the initial parameters.

2. The electronic device of claim 1, wherein the equivariant backbone comprises equivariance with respect to a dihedral group.

3. The electronic device of claim 1, wherein the reflectional matching measures a similarity between a feature fiber and a mirrored counterpart of the feature fiber based on a candidate reflection axis.

4. The electronic device of claim 3, wherein the reflectional matching is performed to be equivariant under a dihedral group, and to be reflection-invariant with respect to a reflection transformation.

5. The electronic device of claim 1, wherein the reflectional matching is performed based on a plurality of spatial scales to compare features within spatial neighborhoods.

6. The electronic device of claim 1, wherein the parameters of the reflection symmetry axis comprise at least one of a midpoint probability, a length, or an orientation of a reflection axis represented by a geometric line.

7. The electronic device of claim 1, wherein the orientational anchor expansion transforms the initial parameters into the parameters of the reflection symmetry axis using a plurality of orientational anchors aligned with a group dimension of the equivariant feature map.

8. The electronic device of claim 7, wherein the orientational anchor expansion comprises aggregating different rotation channels and reflection counterpart channels corresponding to the different rotation channels comprised in the initial parameters.

9. The electronic device of claim 8, wherein the aggregating of the reflection counterpart channels comprises
applying an addition operation to a midpoint parameter and a length parameter of the reflection symmetry axis, and applying a subtraction operation to an orientation parameter of the reflection symmetry axis.

10. The electronic device of claim 1, wherein the instructions, when executed by the at least one processor individually or collectively, cause the electronic device to:
perform rotational matching to compare features at fixed angular intervals based on the equivariant feature map with respect to a candidate rotation center point;
pool the equivariant feature map; and
predict a rotational symmetry center represented by a geometric point, based on a result of the rotational matching and a result of the pooling.

11. The electronic device of claim 10, wherein the rotational matching is performed to be invariant to both rotation and reflection transformations of a dihedral group.

12. The electronic device of claim 10, wherein the instructions, when executed by the at least one processor individually or collectively, cause the electronic device to:
integrate symmetry information into the input image by combining one or more geometric lines corresponding to the determined parameters of the reflection symmetry axis and one or more geometric points corresponding to the predicted rotational symmetry center with the input image.

13. A method of detecting a reflection symmetry axis, the method comprising:
extracting an equivariant feature map by applying an equivariant backbone to an input image;
generating a reflection similarity map by performing reflectional matching based on the equivariant feature map;
predicting initial parameters of a reflection axis based on the equivariant feature map and the reflection similarity map; and
determining parameters of a reflection symmetry axis by performing orientational anchor expansion on the initial parameters.
